(19) United States
(12) Patent Application Publication
(10) Pub. No.: US 2005/0165708 A1
(43) Pub. Date: Jul. 28, 2005

(54) System and method for extending the capabilities of probabilistic networks by incorporating programmable logic

(76) Inventor: Jonathan M. C. Rosenoer, Tiburon, CA (US)

Correspondence Address: Jonathan M. C. Rosenoer, P.O. Box 244, Tiburon, CA, 94920-0244, US

(21) Appl. No.: 11/023,165

(22) Filed: Dec. 28, 2004

Related U.S. Application Data
(60) Provisional application No. 60/533,763, filed on Dec. 30, 2003.

(51) Int. Cl. G06F 9/44; G06N 7/06; G06N 7/02

(52) U.S. Cl. 706/52

(57) ABSTRACT

The present invention has the aim of making more useful the representation of a Bayesian belief network by incorporating programmable logic that extends and improves the capabilities of the network as an engine for a decision-support system. The improved belief network enables a user to create and evaluate one or more conditional states by converting one or more network nodes to function as a logical gate or switch that can turn “on” a new network node.

This invention claims priority based on provisional Patent Application No. 60/533,763 filed on Dec. 30, 2003.

### BACKGROUND OF THE INVENTION

1. Field of the Invention

The present invention relates generally to data processing systems and to Bayesian belief networks having decision graphs. More particularly, this invention relates to systems and techniques for decision support systems utilizing Bayesian belief networks.

The invention also relates to systems and methods for computing the return on investment on goods and services related to risk management and or mitigation.

2. Background

A Bayesian belief network is a representation of the probabilistic relationships among a set of variables. Such networks are referred to in the literature as Bayesian networks, belief networks and probabilistic networks, among other things.

The graphical representation of a belief network includes data nodes to represent variables, and causal links or arcs to represent the dependencies connecting between the data nodes. Associated with each variable in a belief network is a set of probability distributions. A given set of nodes and arcs defines a network structure.

Once a network structure has been found that accurately models a set of data, the model summarizes knowledge about possible causal relationships between the variables in the data set. A primary goal of constructing a Bayesian belief network is to compute posterior probabilities of network variables, i.e., the probability distribution for a particular variable given all its conditioning variables.

Bayesian belief network can be used as the basis for constructing decision support tools. For example, a Bayesian network might be used to model the risk of the occurrence of one or more unwanted events within a system. In such a case, a process may be mapped within a Bayesian network by depicting certain causal inputs, controls, and mitigants as data nodes. So constructed, the network would be able to compute the likelihood of the occurrence of the unwanted event.

### SUMMARY OF THE INVENTION

The present invention has the aim of making more useful the representation of a Bayesian belief network by incorporating programmable logic that extends and improves the capabilities of the network as an engine for a decision-support system. The improved belief network enables a user to create and evaluate one or more conditional states by converting one or more network nodes to function as a logical gate or switch that can turn “on” a new network node. The resulting system can be utilized to underpin a probabilistic “spreadsheet for risk,” which would enable the dynamic evaluation of what-if risk scenarios.

### DETAILED DESCRIPTION OF THE DRAWINGS

These and other features and advantages of the invention will now be described with reference to the accompanying drawings of a certain preferred embodiment, which is intended to provide a more complete understanding of, and not to limit, the invention. In the drawings:

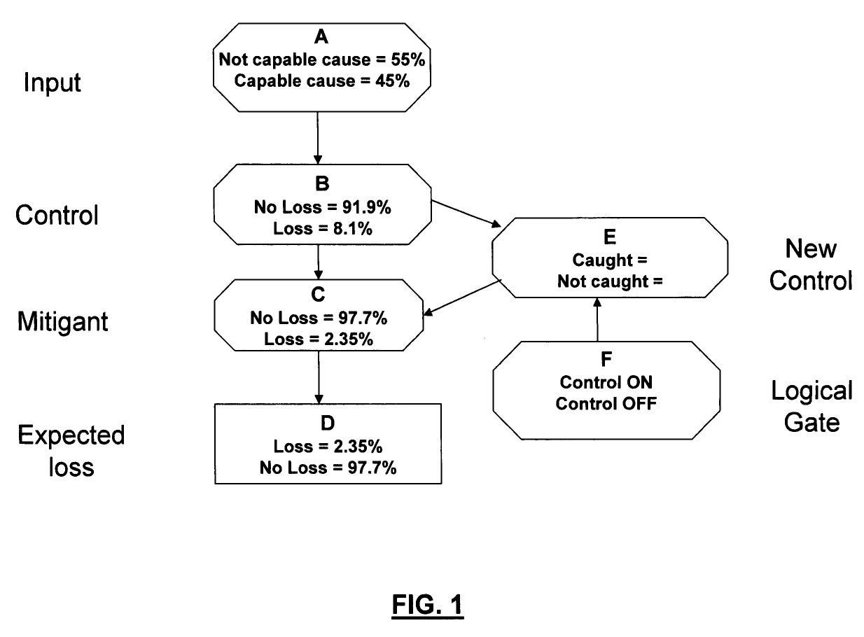

FIG. 1 depicts a process mapped in a Bayesian belief network with variables representing an input (node A), control (node B), mitigant (node C), and posterior probability of the unwanted event (node D). A new control is represented (node E) and is connected to a logical gating function, which is constructed in the form of a variable (node F);

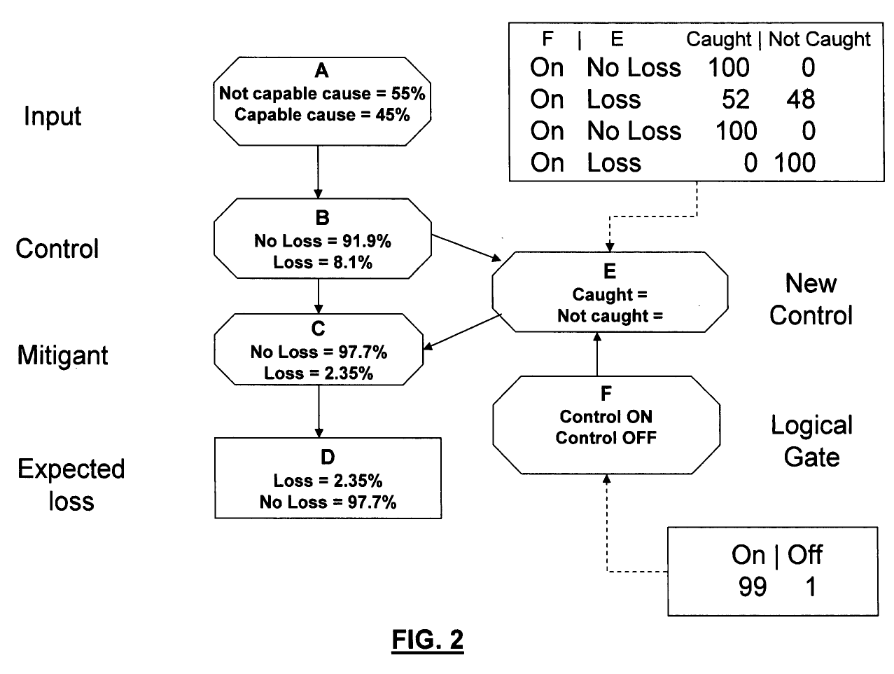

FIG. 2 depicts the probability tables of the new control (node E) and the probability table of the variable (node F) that performs the logical gating function;

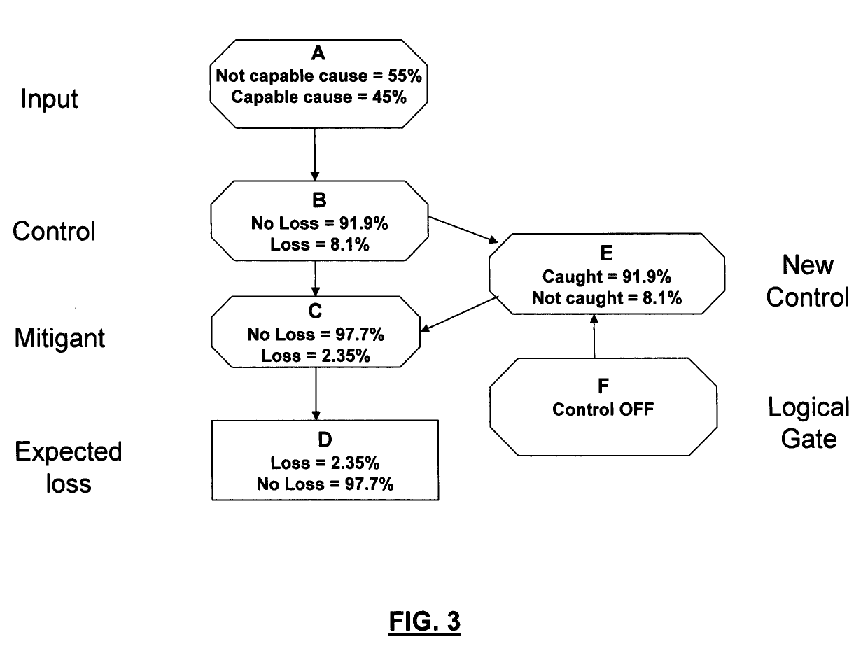

FIG. 3 depicts the Bayesian belief network operating in the absence of the integration of the new control (node E), which is accomplished by holding the gating variable (node F) in the “off” state;

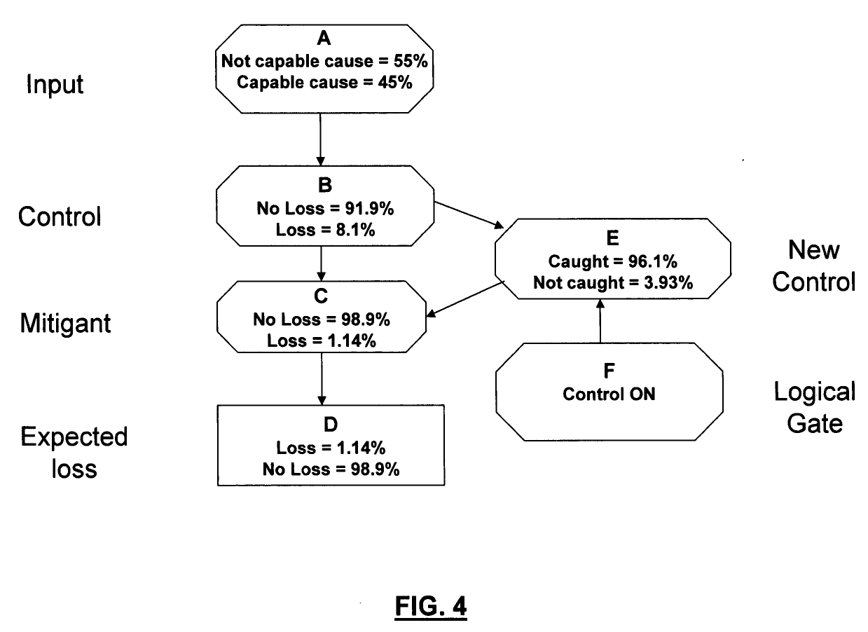

FIG. 4 depicts the belief network operating with the integration of the new control (node E), which is accomplished by holding the gating variable (node F) in the “on” state;

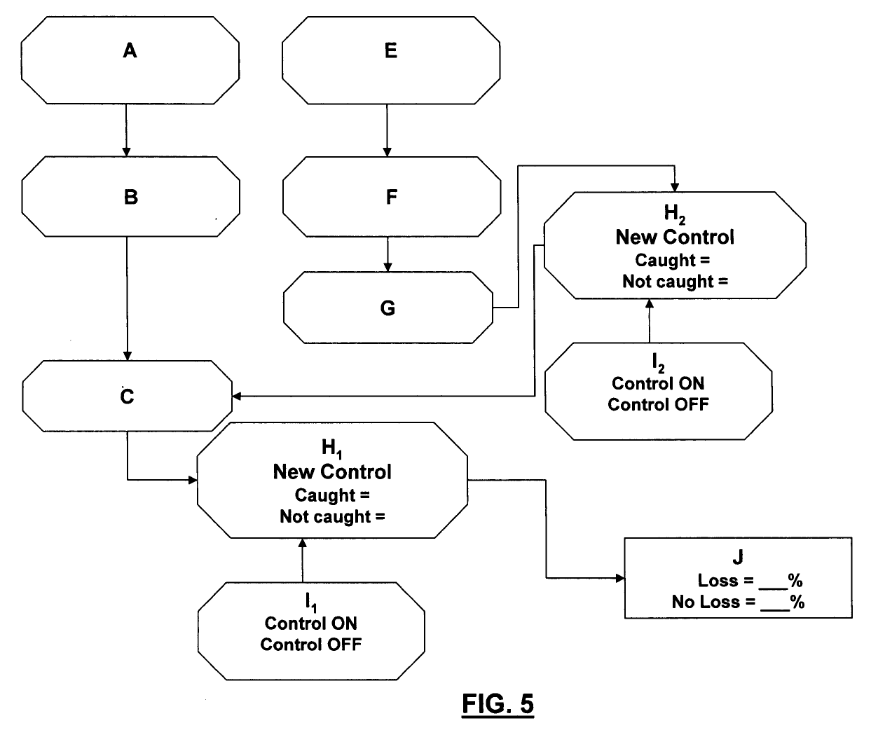

FIG. 5 depicts alternate locations of a new control (at nodes H1 and H2) that a user may efficiently and interactively test, by utilizing logic gates (at nodes I1 and I2), to understand how to optimize the impact and effectiveness of the new control in terms of overall or discrete probability of risk of an unwanted event.

### DETAILED DESCRIPTION OF THE PREFERRED EMBODIMENT

The embodiment of the invention is described in sufficient detail to enable those skilled in the art to practice the invention, and it is to be understood that other embodiments may be utilized and that logical, mechanical, electrical and other changes may be made without departing from the spirit or scope of the present invention. The following detailed description is not to be taken in a limiting sense, and the scope of the present invention is defined only by the appended claims.

Referring now to the drawing (FIG. 1), a computer-implemented method according to an embodiment of the invention is described, and a computerized system according to an embodiment of the invention is described. The exemplary embodiment of the invention is a system and method to incorporate programmable into a Bayesian belief network in order to extends and improves the capabilities of the network as an engine for a decision-support system in the circumstance where the user seeks to understand the impact of introducing a new control or mitigant on the risk of an unwanted event of a occurring within the process or system modeled by the belief network.

The inventive system and method is substantially realized by:
Receiving an initial version of the belief network, the belief network probabilistically relating one or more different input variables to one or more different output decisions, the initial version of the belief network having one or more nodes each with a probability and each having a data structure used for storing the probability;
Introducing programmable logic into any point of the belief network by means of utilizing one or more belief network nodes as logical operators by setting the probabilities at any such node so that,
in the “off” state it does not influence a dependent node or the overall belief network, and
in the “on” state it influences a dependent node and the overall belief network.

In FIG. 1, a process is mapped in with variables depicting an input (node A), control (node B), mitigant (node C), and posterior probability of the unwanted event (node D). A new control is represented (node E) and is connected to a logical gating function, which is constructed in the form of a variable (node F) and functions here to either integrate the new control into the network or separate it from the network, depending on whether it is in an “off” or “on” state.

FIG. 2 depicts the probability tables of the new control (node E) and the probability table of the variable (node F) utilized to perform the logical gating function.

FIG. 3 depicts the belief network operating in the absence of the integration of the new control (node E), which is accomplished by holding the gating variable (node F) in the “off” state.

FIG. 4 depicts the belief network operating with the integration of the new control (node E), which is accomplished by holding the gating variable (node F) in the “on” state.

The data sets such as are represented in FIGS. 1-4 may be regarded as a useful source of information on the choices that a company may make in controlling risk by investment in a new control. For example, the user may construct a belief network representing the risk of loss at a particular level in a process or system. Utilizing the invention, the user would be able efficiently and interactively evaluate the return on investment from the new control in terms of reduction of the expected risk of the unwanted event in the process, without reconstructing.

FIG. 5 depicts alternate locations of a new control (at nodes H1 and H2) that a user may efficiently and interactively test, by utilizing logic gates (at nodes I1 and I2), to understand how to optimize the impact and effectiveness of the new control in terms of overall or discrete probability of risk of an unwanted event.

1. A method implemented in a computer for enhancing a Bayesian belief network (also referred to herein as a “probabilistic network”), including data nodes and causal links, for use in assisting a user in a decision-making process, the method and system comprising the steps of:
Receiving an initial version of the belief network, the belief network probabilistically relating one or more different input variables to one or more different output decisions, the initial version of the belief network having one or more nodes each with a probability and each having a data structure used for storing the probability;
Introducing programmable logic into any point of the belief network by means of utilizing one or more belief network nodes as logical operators by setting the probabilities at any such node so that,
in the “off” state it does not influence a dependent variable or the overall belief network, and
in the “on” position it influences a dependent variable and the overall belief network.

2. The method of claim 1 implemented in a computer wherein one or more Bayesian belief network nodes are utilized as conditional “if-then-else” logical operators and attached to one or more belief network nodes so that the impact on the belief network of one or more variants can be evaluated.

3. The method of claim 1 implemented in a computer wherein:
A Bayesian belief network models the probability of risk of an unwanted event occurring in one or more process flows or systems;
One or more network nodes represent process flow or system inputs in terms of probabilistic data regarding the likelihood of the occurrence of an unwanted event at each node; and,
One or more network nodes are utilized as “if-then-else” logical operators and attached to one or more belief network nodes so that the impact of a new process or system influence can be evaluated.

4. The method of claim 1 implemented in a computer wherein one or more network nodes are utilized as “if-then-else” logical operators so that the impact of one or more network nodes representing process or system controls or mitigants can be evaluated in terms of overall or discrete probability of risk of the occurrence of an unwanted event respecting one or more process flows or systems.

5. The method of claim 1 implemented in a computer wherein one or more network nodes are utilized as “if-then-else” logical operators so that the return on investment on the addition or subtraction of one or more process or system controls or mitigants can be evaluated in terms of overall or discrete probability of risk of an unwanted event respecting one or more process flows or systems.

6. The method of claim 1 implemented in a computer wherein one or more network nodes are utilized as “if-then-else” logical operators so that the efficacy of one or more process or system controls can be optimized in terms of overall or discrete probability of risk of an unwanted event respecting one or more process flows or systems with regard to the positional location of the control(s) within the process or system.
